(19) United States
(12) Patent Application Publication
(10) Pub. No.: US 2012/0278254 A1
(43) Pub. Date: Nov. 1, 2012

(54) Method for Creating Factor Indexes and Long/Short Index Products With Systematic Risk Management

(75) Inventors: Stuart J. Rosenthal, Cranford, NJ (US); William J. Smalley, New York, NY (US); Robert Stanley Tull, Levittown, PA (US)

(73) Assignee: Factor Advisors, LLC, New York, NY (US)

(21) Appl. No.: 13/330,549

(22) Filed: Dec. 19, 2011

Related U.S. Application Data
(60) Provisional application No. 61/424,380, filed on Dec. 17, 2010.

(51) Int. Cl. G06Q 40/06

(52) U.S. Cl. 705/36 R

(57) ABSTRACT

An investment method and process used to create investment indexes that measure the difference between market segments, which such market segments may be in unrelated investment categories or within the same asset class, while simultaneously managing long/short portfolios that return the measured difference in the form of investible index products is disclosed. The three primary steps of the inventive investment method and process are: (1) to identify the desired risk factor for isolation for purposes of hedging existing risk, diversifying risk, or tactical investment in risk; (2) to create and calculate a Factor Index and develop underlying algorithms for intraday and end-of-period benchmarking; and (3) to design a Factor Index Product and implement a Factor Portfolio involving the isolation of the desired risk factor by establishing and maintaining a long exposure to one (or more) market segment(s) and a short exposure to one (or more) market segment(s).

### RELATED APPLICATION

This application claims the benefit of priority to U.S. Provisional Patent Application Ser. No. 61/424,380, filed on Dec. 17, 2010, the contents of which are incorporated into this application by reference.

### TECHNICAL FIELD

The present invention relates generally to investment methodologies and processes, and more particularly, to computerized methods for creating investment indexes that measure differences, and different returns between market segments.

### BACKGROUND OF INVENTION

The ability to isolate risk premia, or Factors, is possible given existing market infrastructure, but such a strategy requires a sophisticated investment process, access to markets, and advanced technology. The ability to readily measure such risk through a Factor Index, and to incorporate Factor Index returns into an automated portfolio management process whereby financial products designed for short-term and/or long-term performance are created, is unique to the disclosed invention.

The invention is a method and process for creating investment indexes that measure the difference between market segments, which may be in unrelated investment categories or within the same asset class, while simultaneously managing long/short portfolios that return this difference in the form of investible index products. The invention, along with component algorithms, is used to measure the risk premium of (or “spread” between) any market segment to another market segment in order to create a “Factor Index,” and ultimately deliver “Factor” returns by way of investible index products. The financial product/products may or may not be listed on public exchanges.

A preferred embodiment of the invention includes a systematic process by which rebalance risks inherent in maintaining target exposure to the two market segments, and therefore, the desired Factor portfolio, is managed automatically by a computerized system using a passive, rules-based methodology, benchmarked to a reproducible index. Additionally, the Factor Indexes can be produced for asset reference points within specific time periods during any trading day such that investors can monitor the desired Factor and their investment in associated financial products on an intraday basis or end-of-day basis based on the availability of the market segments, or “sub-indexes,” used to create the Factor Index.

The returns over time of any asset class or market segment can be measured via indexing. Index returns can represent a specific security, derivative product or commodity, or a group of such instruments, over any time series. In the equity market, by way of example, the S&P 500® Stock Price Index™ is a well-known index which measures the daily price returns of 500 listed large cap stocks in the U.S., as determined by Standard & Poor's. The S&P 500® Index could represent a sub-index of a Factor Index. Also by way of example, the settlement prices of front-month gold futures contracts might be another sub-index of a Factor Index. As provided herein, both the S&P 500® Index and gold price changes are described as components (sub-indexes) of a sample Factor Index. If an investor seeks the relative performance of gold futures to large cap equities, he or she may consider isolating the Gold-S&P 500 risk premium via a Factor Index product. In this example, gold is the “Long” sub-index and the S&P 500® is the “Short” sub-index, where the Factor Index measures the difference in returns between the two.

A common Factor investment strategy is one that attempts to capture the spread of price return between two market segments. In other words, Factor investments seek to isolate the risk premia of one market segment to another market segment. In order to deliver these relative-value returns, one must simultaneously establish a long position in one market segment and a short position in another. Effectively, a Long/Short portfolio must be established as illustrated in FIG. 4. The portfolio is profitable when the long position outperforms the short position. The end-user, the investor, however, is not concerned with the implementation mechanics and maintenance of each individual component, but is instead interested only in capturing the performance of one versus the other.

This investment objective can be simplified: a Factor investor seeks the difference between two market segments, or the return of one market segment minus the return of another market segment. The inventive method manages the buying and selling of sub-index exposure to deliver this difference, with systematic risk management via periodic rebalancing, and the creation of an easily-understood Factor Index.

For real-time risk management, as intended in the inventive method and process, the process must include the continuous capture of the two sub-index values, which may have different market trading conventions altogether, leading to the calculations of the Factor Index values which investors will use as a benchmark for monitoring the desired Factor and their investment in products that intend on isolating the Factor. This requires a computer processor of sufficient capacity to capture real sub-index pricing feeds, calculate the Factor Index value, and store Factor Index values to a computer database. The database will subsequently support the product design process, back testing demands, the additional attribute selections, leading to the final financial product design and the real time pricing of the factor based financial product on public exchanges or the OTC marketplace.

### BRIEF SUMMARY OF THE INVENTION

According to an exemplary embodiment of the present invention, what is disclosed is a computerized method to design real time and end-of-day Factor Indexes that consist of sub-indexes, each an index in its own right, that apply algorithms, using a processor, a computer memory database, and real time and end-of day price feeds on the sub-indexes, to calculate the values of the Factor Index used to design financial products that may be listed on public exchanges, and that are designed to be responsive to various investor risks using various regulatory structures that will change with the underlying changes of the Factor Index and can be maintained to track the financial product's performance in movement with the underlying Factor Index changes over the life of the Factor Product.

A further exemplary embodiment of the present invention is a computerized investment method to create on a real time basis, risk premia indexes that include sub-indexes, said sub-indexes each being an index, comprising a computer processor; a computer memory database; real time price feed information for each of the sub-indexes; wherein the dollar-neutral net asset value (“NAV”) rebalance mechanism, on a “t” frequency for all t>0, is determined using the following algorithm:

NAVxyt*M*[1+(Xt+1÷Xt)−(Yt+1÷Yt)],NAVxyt+1*M*[1+(Xt+2÷Xt+1)−(Yt+2÷Yt+1)], . . .NAVxyn*M*[1+(Xn÷Xn−1)−(Yn÷Yn−1)]

where Xt=absolute value of Index X at NAV calculation time t; Yt=absolute value of Index Y at NAV calculation time t; M=Multiplier or Leverage Factor, M< >0; NAVxyt=Net Asset Value of Long Short Portfolio XY at Time t; and “t” can be defined as 1 or more days (i.e., 2 days, 1 week, 1 month, or 1 year).

It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 is an overview flow diagram of the steps involved in an exemplary embodiment of the present invention from identifying the desired risk factor to the design of a Factor Index Product and implementation of a Factor Portfolio;

FIG. 2 is an graph of an exemplary embodiment of the present invention for a Gold-S&P 500 Factor Index back tested over the last five years;

FIG. 3 is a graph of the daily levels of the S&P 500® (SPX) versus front-month Gold futures contracts for the period from 1995 to the present showing the relative independence of the two; and

FIG. 4 is an overview flow diagram of the steps in an exemplary embodiment of the present invention to create a long/short portfolio.

### DETAILED DESCRIPTION OF THE INVENTION

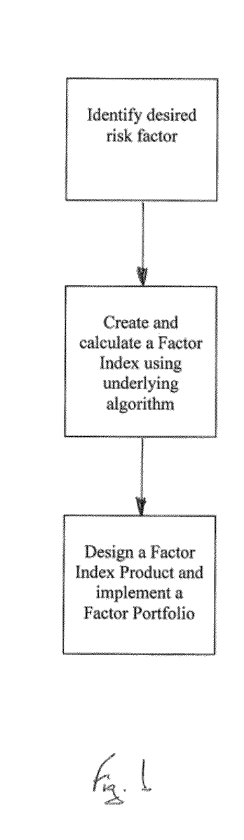

The inventive method comprises a process that combines, using a computer processor: (1) the calculation, both on a real-time and end of period basis, and the dissemination of Factor Indexes that efficiently capture risk premia for both reference and investment product benchmarking purposes; and (2) an automated long/short portfolio management mechanism where simultaneous allocation to long and short positions is systematically rebalanced according to the core investment objective—delivering the spread between two market segments, or a multiple thereof, over a specific time period, in the form of investible index products. The process marries these components in that Factor Indexes provide a streamlined measurement of risk premia which can only be achieved with a long/short portfolio. In turn, the long/short portfolio relies on the index methodology for rebalancing parameters and as a periodic investment target. The process of identifying the desired risk factor to the design of a Factor Index Product and implementation of a Factor Portfolio is illustrated in the flow diagram shown in FIG. 1.

### The Factor Index and Long/Short Factor Portfolio Process Description

In order to deliver a desired Factor return, a long/short spread strategy is employed whereby long and short positions are established in investment vehicles (e.g., index funds, stocks, bonds, physical commodities, futures, etc.) representing the return profiles of two or more respective asset classes or market segments. For example, establishing long exposure to Gold futures and short exposure to the S&P 500® would enable investors to isolate the Gold-Large-Cap US Equity risk premium. This cross-asset spread strategy is concerned only with the value of Gold relative to that of the S&P 500®. Even if both Gold and the S&P 500 decline while the strategy is employed, the strategy should be profitable so long as Gold outperforms the S&P 500. Thus, Factor returns are generated through relative value investing.

Long/short strategies, like the Gold-S&P 500 spread described above, feature more than one directional investment, or “leg.” Because the underlying markets may be volatile and moving independently of one another, sophisticated trading technology and advanced knowledge of trading markets likely is required to implement, monitor, and maintain the desired exposures (i.e., equal notional amounts long Gold and short the S&P 500). Over a given time period, if the long exposure appreciates and the short exposure depreciates, for example, the long/short portfolio is overexposed to the long market segment and underexposed to the short exposure as defined by the desired factor return (i.e., a stated investment objective of 50% long Gold, 50% short S&P 500). The disclosed invention removes leg risk, time lags, and periodic management of more than one distinct position requisite of generating factor returns for the end-user. In a preferred embodiment, the method and process of managing a long/short portfolio to deliver Factor returns is an investment method and process that systematically rebalances the desired long and short exposures (i.e. dollar-neutral/equal notional allocations) as a core component of index methodology.

The long/short portfolio management algorithm includes several variables that are functions of investment objective. Financial “leverage” can act as a multiplier of periodic returns. This can be achieved using margin to buy and sell the instruments that comprise the long and short positions. Similarly, the invention incorporates the ability to express risks on an equal currency investment between the multi-asset classes or unequaled non-dollar neutral strategies, depending on the stated investment objective. In a preferred embodiment of the invention, the ability to capture the Factor returns over different time intervals is incorporated; the long/short portfolio algorithm has a built-in risk management mechanism, as described above, that lends itself to various strategies (from high-frequency trading to buy-and-hold asset allocation) specific rebalancing schedules (i.e., daily, weekly, monthly, quarterly, annually). Each product attribute can be expressed by the algorithms applied to the selected Factor Index and incorporated within the design of the Factor index product needed to serve the end-user. As described below, in exemplary and preferred embodiments, these variables/product attributes work in both index methodology terms and hypothetical Long/Short portfolio (investment product) examples.

### Example 1

### Rebalancing Investment Product with Index X—Index Y Spread Objective

### Let NAVxyₙ=Rebalanced Value of Dollar-Neutral Long/Short Portfolio

NAVxyₜ*M*[1+(Xₜ₊₁÷Xₜ)−(Yₜ₊₁÷Yₜ)]

where

Xₜ=absolute value of Index X at NAV calculation time t

Yₜ=absolute value of Index Y at NAV calculation time t

M=Multiplier, or Leverage Factor, M< >0

NAVxyₜ=Net Asset Value of Long Short Portfolio XY at Time t

for all t>0 in the arithmetic progression:

NAVxyₜ*M*[1+(Xₜ₊₁÷Xₜ)−(Yₜ₊₁÷Yₜ)],NAVxyₜ₊₁*M*[1+(Xₜ₊₂÷Xₜ₊₁)−(Yₜ₊₂÷Yₜ₊₁)], . . .NAVxyₙ*M*[1+(Xₙ÷Xₙ₋₁)−(Yₙ÷Yₙ₋₁)].

Where “t” can be defined as 1 or more days (i.e., 2 days, 1 week, 1 month, 1 year, etc.), and where “t’” is an intraday time frequency (for real-time computer calculation).

This defines the dollar-neutral net asset value (“NAV”) rebalance mechanism on a “t” frequency. Structurally, this algorithm isolates the factor risk premium, or percentage difference in performance, between Index X and Index Y for every t period, thereby automatically adjusting the long and short positions, as closely as possible, dollar-neutrality (netting positions) at the beginning of every t period. This algebraically describes the Factor Index methodology. End-users of Factor index products based on the Index X−Index Y spread measure performance this way − the difference between Index X and Index Y.

Below is a further example of a passively-managed long/short portfolio with the same Index X−Index Y spread objective as the Factor Index methodology as defined by and using the above algorithm.

### Example 2

### Given $10M of Investible Capital

At t: Buy $10M notional Futures Contracts on Index X on margin (50%), Sell $10M notional Futures Contracts on Index Y on margin (50%)
It is useful to note with respect to the margins, that when combining a long and short position, financial leverage in the form of margin must be employed in order to maintain a 1-Beta to the spread between the long and short indices. Without margin, the strategy has a 0.5 Beta.

| | |
|---|---|
| Price of Index X Futures Contract given value | $50 |
| xₜ at t | |
| Futures Contract Multiplier | 1,000 |
| Per Contract | $50,000 |
| Therefore, to obtain $10M desired exposure, | |
| buy 200 contracts | |
| Long position in Index X Futures Contracts | $10,000,000 |

| | |
|---|---|
| Contract Price of Index Y Futures Contract given value | $250 |
| yₜ at t | |
| Futures Contract Multiplier | 100 |
| Per Contract | $25,000 |
| Therefore, to obtain $10M desired exposure, sell | |
| 400 contracts | |
| Short position in Index Y Futures Contracts | $10,000,000 |

At t+1: Index X increases 5%, Index Y increases 3% (a spread of +2%)

| | |
|---|---|
| Price of Index X Futures Contract given value xₜ₊₁ at t + 1 | $52.50 |
| Price of Index Y Futures Contract given value yₜ₊₁ at t + 1 | $257.50 |

Long Position Return = ($52.50 − $50) * 1000 * 200 = $500,000 or +5%
Short Position Return = ($250 − $257.50) * 100 * 400 = −$300,000 or −3%
Long/Short Portfolio Return = ($500,000) + (−$300,000) = $200,000 or +2%

The Portfolio now has $10,200,000 in fund equity, but does not have balanced long/short exposure. The investment objective remains dollar-neutral at the end of every t period, so the portfolio now targets a $10,200,000 allocation to the long position in Index X Futures and $10,200,000 to the short position in Index Y Futures given the prior day's index performance.

Long Position objective: sell $300,000 notional Index X futures to reach target notional of $10,200,000

Sell 5 Index X Futures Contracts at xₜ₊₁=$52.50*1000*5=−$262,500.00 Uninvested cash=$37,500

Long Position in Index X Futures Contracts=$10,237,500 (195 Contracts Long)

Short Position objective: sell $500,000 notional Index Y futures to reach target notional of $10,200,000 (short)

Sell 19 Index Y Futures Contracts at yₜ₊₁=$257.50*100*19=−$489,250.00 Uninvested cash=$10,750

Short Position in Index Y Futures Contracts=$10,189,250 (419 Contracts Short)

The rebalance mechanism buys or sells exposure to Index X or Index Y in order to return them, as closely as possible, to equal notional amounts given the invertible capital resulting from the prior day's index performance in order to maintain, as closely as possible, a 1-Beta to the spread between Index X and Index Y. The notional amount of selling 1 additional contract in both the Index X and Index Y futures would exceed the respective target notional amounts, so the remaining “unallocated” cash ($48,250, in this example) is summed and held in the portfolio in cash and/or cash equivalents.

At t+2: Index X decreases 1%, Index Y decreases 2%

| | |
|---|---|
| Price of Index X Futures Contract given value xₜ₊₂ at t + 2 | $51.975 |
| Price of Index Y Futures Contract given value yₜ₊₂ at t + 2 | $252.35 |

Long Position Return = ($51.975 − $52.50) * 1000 * 195 = −$102,375.00 or −1%
Short Position Return = ($257.50 − $252.35) * 100 * 419 = $215,785.00 or +2.12%
Long/Short Portfolio Return = (−$102,375) + ($215,785) = +$113,410 or 1.11%

The Portfolio now has $10,313,410 in fund equity, has an imbalance in long and short exposure, and must reallocate capital to rebalance, just as it did at t+1.

The following algebraic proof further defines the algorithm for rebalancing the long and short exposures in a Dollar-Neutral construct.

### Trading Ticket: Long and Short Portfolio Mechanics for Rebalancing

$$Let {NAV}_{t} = Net Asset Value at End of Tra di ng Day t , \\ {NAV}_{t} > 0$$

$$Let M = Target Multiplier or Leverage Ratio , M > 0$$

$$Let {R}_{L , t} = Return of Long Index , Trading Day t$$

$$Let {R}_{S , t} = Return of Short Index , Trading Day t$$

$$\begin{matrix}Let {NOTL}_{L , T}^{*} = Target Notional of Long Portfolio at \\ End of Trading Day t \\ = M * {NAV}_{t}\end{matrix}$$

$$\begin{matrix}Let {NOTL}_{S , T}^{*} = Target Notional of Short Portfolio at \\ End of Trading Day t \\ = - M * {NAV}_{t}\end{matrix}$$

### Long Trading Ticket

$$\begin{matrix}Step 1 = Target Notional of Long Portifolio minus \\ Actual Notional of Long Portfolio \\ = {NOTL}_{L , T}^{*} - {NOTL}_{L , T}\end{matrix}$$

$$\begin{matrix}Step 2 = M * {NAV}_{t} - {NOTL}_{L , T - 1} * ( 1 + {R}_{L , t} ) \\ = Target Notional = Multiplier * Net Assets\end{matrix}$$

$${Actual Notional}^{minus} = Prior {Day}^{′} s Long Notional Amount * ( 1 + Long Index Return on t )$$

$$\begin{matrix}Step 3 = M * [ {NAV}_{t - 1} * ( 1 + M * ( {R}_{L , t} - {R}_{s , t} ) ) ] - [ {NOTL}_{L , T - 1} ( 1 + {R}_{L , t} ) ] \\ = Target Notional = Multiplier times \\ [ \begin{matrix}Prior {Day}^{′} s Net Assets times \\ ( \begin{matrix}1 plus Multiplier minus \\ ( \begin{matrix}Difference between Long \\ and Short Index Returns\end{matrix} )\end{matrix} )\end{matrix} ]\end{matrix}$$

$${Actual Notional}^{minus} = Prior {Day}^{′} s Long Notional Amount * ( \begin{matrix}1 + Long Index \\ Return on t\end{matrix} )$$

$$\begin{matrix}Step 4 = Reduce algebraically \\ = ( M * {NAV}_{t - 1} ) + ( {M}^{2} * {R}_{L , t} * {NAV}_{t - 1} ) - ( {M}^{2} {R}_{S , t} * {NAV}_{t - 1} ) - \\ ( M * {NAV}_{t - 1} ) - ( M * {R}_{L , t} * {NAV}_{t - 1} ) \\ = ( {M}^{2} * {R}_{L , t} * {NAV}_{t - 1} ) - ( {M}^{2} * {R}_{S , t} * {NAV}_{t - 1} ) - ( M * {R}_{L , t} * {NAV}_{t - 1} ) \\ = {NAV}_{t - 1} [ ( {M}^{2} * {R}_{L , t} ) - ( {M}^{2} * {R}_{S , t} ) - ( M * {R}_{L , t} ) ] \\ = {NAV}_{t - 1} [ {M}^{2} ( {R}_{L , t} - {R}_{S , t} ) - ( M * {R}_{L , t} ) ] \\ = {NAV}_{t - 1} [ ( {M}^{2} - M ) * {R}_{L , t} - ( {M}^{2} * {R}_{S , t} ) ] \\ = {NAV}_{t - 1} [ M * ( M - 1 ) * {R}_{L , t} - ( {M}^{2} * {R}_{S , t} ) ]\end{matrix}$$

### Short Trading Ticket

$$\begin{matrix}Step 1 = Target Notional of Short Portfolio minus \\ Actual Notional of Short Portfolio \\ = {NOTL}_{S , T}^{*} - {NOTL}_{S , T}\end{matrix}$$

$$\begin{matrix}Step 2 = - M * {NAV}_{t} - {NOTL}_{S , T - 1} * ( 1 + {R}_{S , t} ) \\ = Target Notional = Multiplier * Net Assets\end{matrix}$$

$${Actual Notional}^{minus} = Prior {Day}^{′} s Short Notional Amount * ( 1 + Short Index Return on t )$$

$$\begin{matrix}Step 3 = - M * [ {NAV}_{t - 1} * ( 1 + M * ( {R}_{L , t} - {R}_{S , t} ) ) ] - \\ [ {NOTL}_{S , T - 1} * ( 1 + {R}_{S , t} ) ] \\ = Target Notional = Multiplier times \\ [ \begin{matrix}Prior {Day}^{′} s Net Assets times \\ ( \begin{matrix}1 plus Multiplier times \\ ( \begin{matrix}Differences between Long and \\ Short Index Returns\end{matrix} )\end{matrix} )\end{matrix} ]\end{matrix}$$

$$Actual Notional = Prior {Day}^{′} s Net Short Assets * ( 1 + Short Index Return on t )$$

$$\begin{matrix}Step 4 = Reduce algebraically \\ = ( - M * {NAV}_{t - 1} ) + ( - {M}^{2} * {R}_{L , t} * {NAV}_{t - 1} ) + ( {M}^{2} * {R}_{S , t} * {NAV}_{t - 1} ) + \\ ( M * {NAV}_{t - 1} ) + ( M * {R}_{S , t} * {NAV}_{t - 1} ) \\ = ( - {M}^{2} * {R}_{L , t} * {NAV}_{t - 1} ) + ( {M}^{2} * {R}_{S , t} * {NAV}_{t - 1} ) + ( M * {R}_{S , t} * {NAV}_{t - 1} ) \\ = {NAV}_{t - 1} [ \begin{matrix}( - {M}^{2} * {R}_{L , t} * {NAV}_{t - 1} ) + \\ ( {M}^{2} * {R}_{S , t} * {NAV}_{t - 1} ) + ( M * {R}_{S , t} * {NAV}_{t - 1} )\end{matrix} ] \\ = {NAV}_{t - 1} [ {M}^{2} ( {R}_{L , t} - {R}_{S , t} ) + ( M * {R}_{S , t} ) ] \\ = {NAV}_{t - 1} [ ( {M}^{2} + M ) * {R}_{S , t} - ( {M}^{2} * {R}_{S , t} ) ] \\ = {NAV}_{t - 1} [ M * ( M + 1 ) * {R}_{S , t} - ( {M}^{2} * {R}_{L , t} ) ]\end{matrix}$$

The rebalance mechanism and overall investment strategy are rules-based and passive, and can be replicated in the form of an index. By purchasing exposure to one market segment and simultaneously selling exposure to another, as detailed by the above described Long/Short portfolio allocation algorithms, the difference, or spread, in performance is the isolated “Factor.” Therefore, a Factor Index, which represents a theoretical long/short portfolio, can be synthetically constructed by subtracting the performance of the desired short exposure from the desired long exposure. A Factor Index serves as benchmark for the Long/Short investment process described above for the basis of financial products and for settlement of index-based derivative instruments.

By way of exemplary embodiment, as shown above, at t+1, Index X (the “Long” sub-index) increased 5%, while Index Y (the “Short” sub-index) increased 3%. At t+1, the Index X−Index Y Risk Premium Index (the Factor Index) would increase 2%, reflecting the difference between the two sub-indexes. Assuming a base index level of 100, the new Factor Index level is 102 at t+1. The following period, t+2, Index X decreases 1% and Index Y decreases 2%. The Factor Index would therefore increase 1% since Index X minus Index Y equals +1% at t+2. The Factor Index would increase again to 103.2, or +1%.

In a preferred embodiment, the Long/Short Portfolio product and the Factor Index have the same investment objective, where the Factor Index is the Portfolio product's benchmark. The two will deliver the same results except for the transaction costs associated with managing the portfolio and the percentage differences for the same dollar movement in short positions.

Certain product design concepts are relevant to various preferred embodiments of implementations of the invention. Such concepts include, without limitation, correlation of Factor Sub-Indexes, equal weighting of long/short exposure, costs associated with product structures, leverage, rebalancing, selection of NAV calculation points, and intraday values of Factor Products. Each of these design concepts are described in further detail below.

### Correlation of the Factor Sub-Indexes

Key to the selection of sub-indexes is the historical returns of each sub-index and the relationship of the returns of one to the returns of the other—statistically, their correlation—over time. For efficiency and accuracy, and for periods greater than several days, this correlation must be accomplished by a computerized processing unit with historical time series data of each of the sub-index returns is needed in order to perform the correlation of the two proposed sub-indexes to each other. Once the correlation of the two sub-indexes is known, the analysis will suggest a possible weighting of each returns as part of the construction of a Factor Index.

Factor Index theoretical return calculations for an extended, continuous period of time will use the results of the selected sub-indexes over time to create a Factor Index time series return database. If the investment product design invested equal dollar amounts into the long sub-index and the short sub-index the expected product returns of the Factor Index would be referred to as beta returns.

Typically the Factor Index returns are based upon the percentage of price performance differences between the two sub-indexes. For the purpose of this description, the focus will be on the price performance differences. The sub-indexes can consists of price returns based upon, by way of example, the following: value equities verses growth equities, small capitalized equities verses large capitalized equities, US stocks verses international stocks, high momentum stocks verses low momentum stocks, volatility returns, liquidity returns, earnings returns, dividends returns, and any market segment that indicates the long and short price returns investors are looking to isolate and measure.

### Equal Weighting of Long/Short Exposure

To measure Factor Index beta returns requires equal weighted exposure to the long sub-index and short sub-index. In this manner Factor Index performance is represented by the difference in performance between the two sub-index returns. Discussions on the principal of equal weighting in the two sub-indexes are referred to as dollar neutral or balanced long/short investing returns. Factor Indexes created in this manner are referred to as the 1 beta factor returns or single beta returns.

It is possible to have Factor Indexes that are not equal exposure weighted (i.e., Dollar-Neutral). However, the returns of these indexes do not isolate the return spread between the sub-indexes. The disclosed method, specifically the rebalance mechanism and the index calculation, operates the same way as if the strategy was Dollar-Neutral but could be, by way of example, extended in unbalanced sub-index exposures.

Costs Associated with Various Product Structure

An analysis of historical Factor Index returns is the initial process step to establishing a beta product design. In a preferred embodiment of the invention, the analysis of the one beta spread returns will lead to the initial beta product design and will support the decision for the initial legal, tax and regulatory financial product design. Without the Factor Index database values the disclosed invention could not apply algorithms to back test a product's expected return set during specific time series. Initial beta product design decisions will include the anticipated target investor ownership costs, by way of example, such as: investment management fees, custodial fees, trustee fees and other service provider fees, financing costs, and anticipated tracking variance to the Factor Index.

Expected investor returns will be specific to the financial product types such as: funds, structured notes, commodity pools, derivative OTC products, swaps, and various international product types. Financial product designs must consider the necessary fee structure to investors and must focus specifically on reaching the largest investor group with the lowest possible fee structure, within the product set, in order to achieve the highest net investment returns to investors and gather the maximum assets under management. The back testing of anticipated product types requires the use of the inventor's algorithms and the Factor or Spread index returns.

Product ownership costs differ between product structure types as the service providers have different fee rates that are driven by regulatory reporting, tax reporting, balance sheet usage of OTC counterparty and the competitive markets.

The mutual fund structure is the most familiar product structure for retail investors. The fees can be 5 basis points, or lower, as an expense ratio to in excess of 300 basis points in expense fees. Structured notes have different level of fees as their structure implies balance sheet usage of the issuer, financing costs and hedging costs. These costs could be 300 basis points or greater. Over the counter (“OTC”) commodity pools/managed futures accounts also have an implied higher cost to investor to cover the K-1 tax form preparation, high transaction costs for rolling futures, and the embedded costs of purchasing swaps. These fees could be 200 to 300 basis point annually plus 20 to 30 percent of any returns in excess of the designated benchmark asset.

Fees are not the only consideration in the product type selection. In a preferred embodiment, the invention may also consider the financial knowledge the target investor is likely to have. For example, if the target client is a retail investor then in a preferred embodiment, the inventive method and system will try to choose a product type that is overall tax neutral in nature to other product offerings the investor typically chooses from. However, if the product structure has higher tax burdens or additional regulatory reporting that the investor may not be familiar with, the inventive method and system may seek to deliver the product in another regulatory structure that is less efficient, but more familiar to the investor.

If the target investor group has ownership limits on certain product structure type then this could require the inventive method and system to select an alternative product legal structure that does not suffer from these ownership restrictions. Derivative based products would tend to fall into this category.

The other product decision that is directly based on the target investor group is the principle of listed or OTC traded products. Certain institutional clients may prefer to acquire long/short exposure through an OTC product. Retail investors may prefer the product to trade on a public exchange.

Each of these products types have implied costs that investors must be willing to bear based upon anticipated product returns, ease of ownership and the risks that are being isolated by the product.

### Leverage

A second layer of product attributes can be added to the beta product design to give it additional performance attributes which may improve investor returns and minimize the impact of fees on investors. The attributes may include a “multiplier” on the anticipated beta returns, or “leverage.”

The leverage attribute can be used to determine if the product's beta design can be modified to increase net returns to investors over product life periods of 1-, 3-, 5-, and 10-years, or greater, for each specific financial product security type. Leverage to investors is reflected in the form of a multiplier which will increase or decrease the product's volatility and hence the Factor based product returns. This analysis would not be possible without using a computer processing unit, time series Factor Indexes data, database of specific financial product type fee structures, and algorithms to determine the net returns to investors for various leverage increments. The product type Factor Index returns for each level of leverage will result in the selection of product attributes that can decrease beta fee expenses to investors and enhance the competitive product positioning.

### Rebalancing

Rebalancing techniques are another product attribute that may be added to the design of factor/spread based products in order to achieve specific performance path alternatives over time. Rebalancing alternatives are achieved through daily, weekly, monthly or annual rebalancing. These rebalancing techniques allow potential investors in Factor Index products to analyze expected return paths based upon each target investor group's tolerance, or lack of tolerance, for the specific price and volatility in the return risks and the compounding effects of these return risks on the value of the factor based financial product. Price performance paths vary in accordance to rebalancing time periods. The above analysis shows an example of rebalancing frequency.

Both leverage and rebalancing, as key elements of the business method, are variable product attributes that are functions of end-user demand. The target investor group is a key component of the final product design as they provide guidance on the selection of risk factors to index, financial product types, leverage factors, and rebalancing periods. A computer processor and a time series database of Factor Index returns is required in order for the inventive method and system to determine the correct path of product return most appropriate for each targeted investor group for various rebalancing periods.

### Selection of Net Asset Value Calculation Points

The measure of how a financial product's performance can be viewed by investors may also be in the form of an end-of-day exchange price. Another measure of financial product performance is the end-of-day net asset value per share or “NAV.” NAVs are unique to funds, trusts, partnerships and commodity pools.

NAV prices are typically calculated at the end-of-day using the closing prices of the underlying assets. However Factor NAVs create an additional level of complexity because the underlying constituents are themselves indexes. Each sub-index of the Factor Index may or may not have the same closing time during the business day and thus could create a market time mismatch.

A Factor Product needs to be rebalanced, no matter what the rebalancing period may be. In other words, when both sub-index related products are open in the market. This will automatically create a variance between the Factor Index performance and product benchmarked to a Factor Index. This tracking variance incorporates the sub-index product levels at the rebalancing periods. The Factor NAV should be struck at the time immediately preceding the rebalancing of the Factor product to the sub-index products in order to preserve the beta component of the product.

If the Factor Product is listed on a public exchange this will add additional complexity to the Factor Product. The Factor Product may need to rebalance prior to the close of the exchange when the sub-index products are open. This will almost certainly lead to the NAV price differing from the exchange closing price of the Factor Product. The exchange closing price may include changes due to market news events that occurred after the NAV price was struck.

### Intraday Values of Factor Products

For factor product that trade on public exchanges, the exchanges or regulators will often require the real time prices of the sub-index values, the real time values of the Factor Index, and the real time indicative intraday value (“IIV”) of the Factor Product. These values must be calculated on a computer processor, from a database of real time price/index feeds and published to the target investor group. In this manner investors can value exchange prices being made by market makers and determine if the price is fair relative to the theoretical value at that point in time.

In a preferred embodiment of the invention, intraday values require the capture of real time index values in order to capture and publish to the market the fair value of the Factor Product every 15 seconds. The 15 second calculation is performed against a database that captures the real time index values every 1 to 5 seconds depending on the inbound data feed of product prices and index values.

Some sub-indexes may only be calculated at the end of day, but the products contained with the Factor Product may trade intraday and therefore the rebalancing of the end of day products would need to be an approximation which represents the estimated closing levels of the end-of-day sub-indexes.

The variance of the Factor Product to the Factor Index is referred to as tracking variance. Tracking variance reflects the product timing difference between the sub-index closing times and the product trading times. In addition, the tracking variance will include the impact of product ownership costs as the index has no frictional costs and the products reflect the implied legal, tax and product management fees.

In summary, the invention requires a computer processor, a Factor Index times series database, and specific calculation algorithms that stores and computes the expected Factor Index price returns from correlated and non-correlated sub-index returns that can be achieved through specific selection of regulatory product types, leverage variables, periodic rebalancing periods as determined from Factor index values and the sequencing of the algorithm calculations in the Factor base product design process.

Once the Factor Index values have been calculated they must be stored to a computer database in order to support the initial and final factor based financial product design. The time series Factor Index data and the correlation of the sub-indices to each other will support the selection of sub-indexes for the product design types. The Factor Index values using multiplied by “1” is referred to as the one beta Factor Index return or beta spread return. By increasing the leverage factor above or below “1” the price return path will be changed. By increasing leverage the inventive method and process can increase or decrease the price volatility of the Factor Index returns compared to the volatility of the 1 beta spread return. Increased leverage may also be referred to as a “multiplier” and a multiplier will reduce the single beta cost of the product to investors, and will increase the daily price volatility. Without the Factor Index database the return analysis for the leveraged factor product design could not be accomplished.

In addition to the financial leverage embedded in the product structure via margin, and in the index methodology in the form of a multiplier or leverage ratio, the frequency of long/short exposure rebalance is another key component in the product design that determines expected volatility and total return beyond the stated rebalance frequency. Periodic rebalances are critical for managing leg risk. Without the rebalance mechanism, the long and short exposures will vary as the underlying market segments fluctuate over time. Rebalancing effectively compounds periodic returns, making the total return of the product a function of the periodic volatility of the underlying market segments. Furthermore, in volatile markets, a more frequent rebalance schedule likely will result in a lower total return when considering periods of time longer than the investment objective.

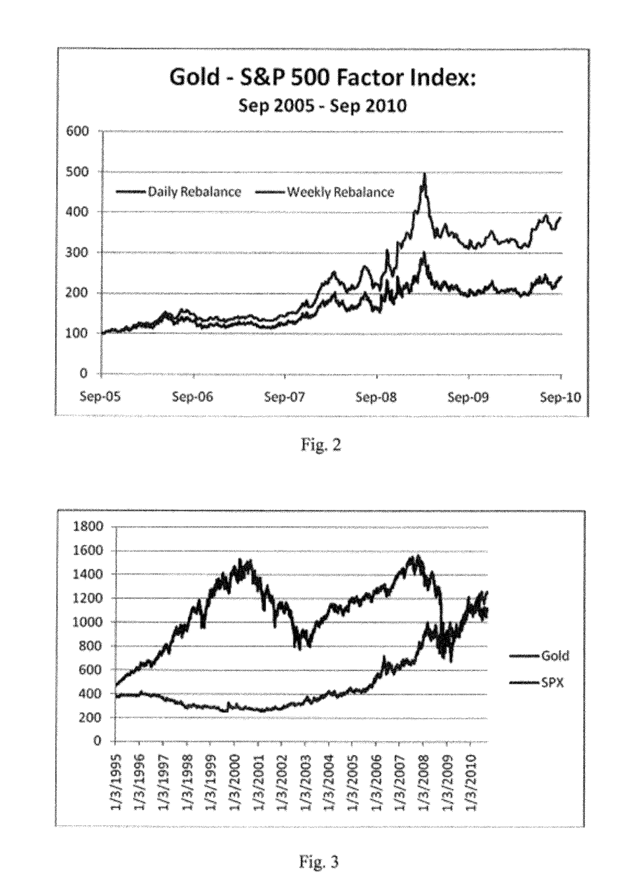

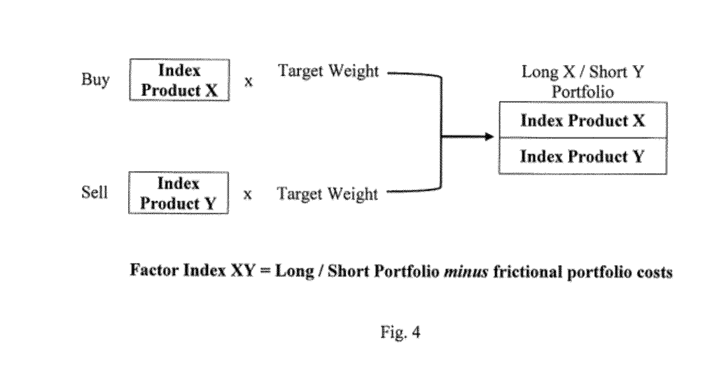

Similarly, in trending markets, a more frequent rebalance schedule likely will have a positive impact on total return over longer periods. The automatic rebalance mechanism is a byproduct of the strategy's investment objective, which may be daily, weekly, monthly, quarterly, or annually in horizon. The disclosed invention provides an investment process by which desired exposure is automatically maintained over time. Therefore, the rebalance frequency and tolerance for decay over investment periods may be trade-offs in volatile markets, and complements in trending markets. As shown in FIG. 2 is an example of a Gold-S&P 500 Factor Index back test over the last five years—at times an unusually volatile market for both commodities and equities.

Similarly, the correlation of the underlying market segments is an important element in any spread strategy. If the Long and Short sub-indexes are highly correlated, the expected differences in periodic return should be relatively small, reducing volatility in the product. If the two indexes have a perfect +1.0 correlation, they have identical returns. Therefore, a long position in one index product and a short position in another should net the investor a return of 0% since they perfectly offset. At the same time, if the sub-indexes exhibit strong negative correlations, the expected differences in periodic return should be relatively wide, thereby increasing volatility. When the Long Index increases, the Short Sub-Index decreases by the same amount, and therefore, the spread is twice as large as the absolute return of each individual sub-index. As shown in FIG. 3 the daily levels of the S&P 500® (SPX) versus front-month Gold futures contracts. Since 1995, the two have exhibited a +0.12 correlation, which signals a relatively independent relationship.

A further example using the algorithms of a preferred embodiment of the present invention is described in the following Example 3.

### Example 3

### A Factor Product Based Upon a Two Levered Factor Index

### Day 1:

The factor product consists of $100 million in investor assets, the leverage factor of 2 and the levered exposure is therefore $200 million long and $200 million short for an overall factor product notional exposure of $400 million. For purposes of this example the Factor Index level is 100.

### Day 2:

The Factor Index beta level changes by 2% to 98 and when the leverage is applied to the asset base, the results in a −4% change in the notional value of the factor product's asset base or Assets Under Management (“AUM”). The long and short notional leveraged values must be rebalanced to reflect the change in AUM.

To rebalance the fund AUM to $96 million the inventive method and process would readjust the notional exposure of the two product sides to the product's asset base. The product is designed to remain dollar neutral to the long and short product exposure on a daily basis. In the product example above the product's long sub-index exposure requires the investor to sell $6 million of notional long holdings. The short asset side now needs to buy back $10 million of additional short side exposure in order to remain dollar neutral against the of the product asset change from $100 million to $96 million ($2 million lost on the long side and $2 million loss on the short side after leverage is applied).

The relationship between the sub-index changes and hence the Factor Index values is not obvious relative to the rebalancing of the spread product's notional asset exposure. The algorithms disclosed herein show the necessary calculations to manage the rebalancing process for leverage factor products benchmarked to a Factor Index.

A number of embodiments of the invention have been described herein. It is to be understood that various modifications may be made without departing from the spirit and scope of the invention. By way of example only, although the embodiments have been described with reference to gold and equity indexes that compose a Factor Index and, therefore, a Long/Short Factor Portfolio, other leveraged products that are based on an index could use the tools described herein. As such, the products could be bonds, economic indicators, real property and so forth. Accordingly, all such other embodiments are intended to be within the scope of the following claims.

What is claimed is:

1. A computerized method to design real time and end-of-day Factor Indexes that consist of sub-indexes, each an index in its own right, that apply algorithms, using a processor, a computer memory database, and real time and end-of day price feeds on the sub-indexes, to calculate the values of the Factor Index used to design financial products that may be listed on public exchanges, and that are designed to be responsive to various investor risks using various regulatory structures that will change with the underlying changes of the Factor Index and can be maintained to track the financial product's performance in movement with the underlying Factor Index changes over the life of the Factor Product.

2. A computerized investment method to create on a real time basis, risk premia indexes that include sub-indexes, said sub-indexes each being an index, comprising:
a computer processor;
a computer memory database;
real time price feed information for each of the sub-indexes;
wherein the dollar-neutral net asset value (“NAV”) rebalance mechanism, on a “t” frequency for all t>0, is determined using the following algorithm:
NAVxyt*M*[1+(Xt+1÷Xt)−(Yt+1÷Yt)],NAVxyt+1*M*[1+(Xt+2÷Xt+1)−(Yt+2÷Yt+1)], . . .NAVxyn*M*[1+(Xn÷Xn−1)−(Yn÷Yn−1)]
where Xt=absolute value of Index X at NAV calculation time t; Yt=absolute value of Index Y at NAV calculation time t; M=Multiplier or Leverage Factor, M< >0; NAVxyt=Net Asset Value of Long Short Portfolio XY at Time t; and “t” can be defined as 1 or more days (i.e., 2 days, 1 week, 1 month, or 1 year).

3. The computerized investment method of claim 2 to create risk premia indexes that include sub-indexes, wherein the calculations provide for end-of-day Factor Indexes.

4. The computerized method to design Factor Indexes of claim 1, further comprising rebalancing algorithms that permit systematic management of investible long/short portfolio products according to specified Factor Index methodologies.

5. The computerized method to design Factor Indexes of claim 4, using the following rebalancing algorithm:
NAVxyt*M*[1+(Xt+1÷Xt)−(Yt+1÷Yt)],NAVxyt+1*M*[1+(Xt+2÷Xt+1)−(Yt+2÷Yt+1)], . . .NAVxyn*M*[1+(Xn÷Xn−1)−(Yn÷Yn−1)]
where Xt=absolute value of Index X at NAV calculation time t; Yt=absolute value of Index Y at NAV calculation time t; M=Multiplier or Leverage Factor, M NAVxyt=Net Asset Value of Long Short Portfolio XY at Time t; and “t” can be defined as 1 or more days (i.e., 2 days, 1 week, 1 month, or 1 year).

6. The computerized investment method of claim 2 to create risk premia indexes that include sub-indexes, wherein the algorithm calculates the values of two or more sub-indexes in order to construct a Factor Index using algorithms, and constructs historical Factor Indexes analyzed and used to develop a theoretical Factor Product.

7. The computerized method and process to design real time and end-of-day Factor Indexes of claim 1, that systematically and passively manages long/short portfolios, in accordance with predetermined Factor Index algorithms, by automatically purchasing and/or selling long and/or short exposure in order to maintain target portfolio exposure.

8. The computerized method to design Factor Indexes of claim 7, using the following Factor Index algorithm:
NAVxyt*M*[1+(Xt+1÷Xt)−(Yt+1÷Yt)],NAVxyt+1*M*[1+(Xt+2÷Xt+1)−(Yt+2÷Yt+1)], . . .NAVxyn*M*[1+(Xn÷Xn−1)−(Yn÷Yn−1)]
where Xt=absolute value of Index X at NAV calculation time t; Yt=absolute value of Index Y at NAV calculation time t; M=Multiplier or Leverage Factor, M< >0; NAVxyt=Net Asset Value of Long Short Portfolio XY at Time t; and “t” can be defined as 1 or more days (i.e., 2 days, 1 week, 1 month, or 1 year).

9. The computerized method and process to design real time and end-of-day Factor Indexes of claim 1, further comprising a means for capturing real time value changes of the underlying sub-index values, using the real time changes in the sub-index values to construct a real time Factor Index value using predetermined algorithms, storing the real time generated Factor Index values to a computer database, managing the ongoing performance of a Factor Product on a daily basis, when the Factor Product sub-indexes are being calculated on a real time basis.

10. The computerized method and process to design real time and end-of-day Factor Indexes of claim 1, further comprising means to capture changes in a Factor Product on a real time and end-of-day basis, and adjusted to determine the impact of ownership costs, as determined from competitive product ownership costs, which can then be applied to other product attributes including leverage, rebalancing points during rebalancing time periods and sub-index value changes and can be used to lower the beta Factor Product investor ownership costs using an enhanced Factor Product.

11. The computerized method and process to design real time and end-of-day Factor Indexes of claim 1, further comprising a means of capturing real time value changes of the underlying sub-index values and using the real time changes in the sub-index values to construct a real time Factor Index value, storing the real time generated Factor Index values to a computer database and algorithms that will permit management of the ongoing performance of an Enhanced Factor Product for any business day when all of the Enhanced Factor Product sub-indexes are being produce on a real time basis.

12. The computerized method and process to design real time and end-of-day Factor Indexes of claim 1, further comprising using a processing unit, algorithms and database of sub-indexes values and beta Factor Index values to produce risk adjusted, fee adjusted series of Factor Product return paths each containing various product attributes to estimate the gross and net returns.

13. The computerized method and process to design real time and end-of-day Factor Indexes of claim 1, further comprising a method to rebalance Beta Factor Products and Enhanced Factor Products to the changes in the beta Factor Index using a computer processor, algorithms, a current database of sub-index values, product leverage, rebalancing set points and trading techniques to match the changes in the Factor Products to the changes in the Factor Index closing values for a business day.

14. The computerized method and process to design real time and end-of-day Factor Indexes of claim 1, further comprising a method to capture investor demand and convert the investor demand into Factor financial products and to maintain the performance of the Factor financial product to the terms and condition of a prospectus or offering document.

15. The computerized method and process to design real time and end-of-day Factor Indexes of claim 1, further comprising a method using predetermined algorithms to calculate how intraday rebalancing points can be established for Beta Factor Products and Enhanced Factor Products to capture key liquidity points for assets held within the Factor Products.
